(19) United States
(12) Patent Application Publication
(10) Pub. No.: US 2015/0136695 A1
(43) Pub. Date: May 21, 2015

(54) Systems and Methods For Cleaning A Membrane Separation System

(71) Applicant: Kevin Lucas, Greenwood, WI (US)

(72) Inventor: Kevin Lucas, Greenwood, WI (US)

(21) Appl. No.: 14/536,094

(22) Filed: Nov. 7, 2014

Related U.S. Application Data
(60) Provisional application No. 61/901,920, filed on Nov. 8, 2013.

(51) Int. Cl. B01D 65/02

(52) U.S. Cl. CPC B01D 65/02; B01D 2321/04; B01D 2321/08; B01D 2321/168
USPC 210/636

(57) ABSTRACT

Systems and methods for cleaning a membrane filtration system using cross-flow geometry.

### CROSS REFERENCE TO RELATED APPLICATIONS

This application claims benefit of U.S. Provisional Patent Application No. 61/901,920 filed Nov. 8, 2013, the entire disclosure of which is incorporated herein by reference.

### BACKGROUND

1. Field of the Invention

This disclosure is related to the field of membrane filtration, specifically to methods for cleaning such systems.

2. Description of the Related Art

This disclosure is related to the field of membrane filtration, specifically to methods for cleaning such systems.

Many industrial setting membrane filtration systems separate gaseous or liquid streams, generally by removing certain solid particulates from them. Unlike chemical processes, such as distillation, sublimation, and crystallization, membrane separation generally operates without the application of heat, and thus requires less energy. Sometimes also known as “cold membrane technology,” these systems use physical rather than thermal processes, and are widely used in the food, dairy, biotechnology, pharmaceutical, and more recently wastewater treatment industries.

Membrane separation generally uses a permeable membrane to remove particles, where the membrane is generally made from a synthetic material containing a plurality of openings or “pores” each of which is no larger than a certain threshold pore size. This maximum pore size is sometimes referred to as the “nominal pore size.” Another measure, the nominal molecular weight cut-off, or MWCO, is often used to identify, within a certain tolerance range, the smallest particles which will be retained by (e.g., not pass through) the membrane, usually in terms of the molecular weight. The type of solid particulates removed by a given membrane generally depends on the type of membrane, and the size of the pores in the membrane, as compared to the typical size of the solid particulate.

There are two primary flow geometries in a membrane separation system: cross-flow, and dead-end. In a cross-flow geometry, pressure is used to drive a stream of fluid (typically liquid) containing particles (known as the “feed”) in a flow that is tangential to the membrane surface. As the flow moves across the membrane surface, some amount of the particles in the feed having a diameter smaller than the nominal pore size of the membrane will pass through the membrane. The particles which pass through the pores are known as “permeate” or “filtrate.” The remainder of the feed, known as “retentate,” passes over the membrane but does not pass through the pores.

A series of membranes are often utilized in a cross-flow geometry to further remove particles until some desired amount of particles are removed. In certain embodiments, retentate is recirculated to pass over the same membrane or set of membranes repeatedly to remove particles not removed in a prior pass. Over time, certain particles adhere to the membrane but do not pass through it, reducing the efficiency of the membrane. These particles are generally known as “foulants.” The membrane should be periodically cleaned to remove foulants, preserve the membrane's operational life, and maintain high levels of membrane performance.

Current cleaning methods are time-consuming, expensive, and hard on the membranes, often involving the use of four different chemical washes and a rinse cycle after each such wash. These methods can require the system to be taken off-line for three or more hours at a time. Large amounts of clean water must be consumed when rinsing and flushing the system. Some of the cost efficiency gained in a membrane system by avoiding the energy needs of thermal separation is lost in the operational overhead of cleaning the systems. Further, even where the flow geometry of the membrane is cross-flow, prior art cleaning systems generally work by building up fluid pressure in an attempt to increase trans-membrane pressure to base line (“TMP”) (rather than cross-flow pressure) and thereby force more fluid through the membrane.

However, high TMP reduces the cross-flow rate of wash solution across the membrane, thereby inhibiting removal of foulants and in many cases further packing them, such as by pushing lodged particulate further into the pores. This may encourage redeposition of removed particles.

Prior art methods include an initial cleaning step using fresh water alone before chemical cleaners are incrementally added to reach a particular concentration. This wastes water, and the concentration is usually not determined by checking soil load levels. Prior art methods also generally include a fresh water rinse cycle between the chemical rinse and the final flush. This prolongs downtime and consumers more fresh water, driving up opportunity cost and operational cost. Prior art methods also do not make efficient use of cleaning solution, requiring the use of multiple expensive and environmentally hazardous chemicals. Prior art methods also use measurements of pressure taken at end-line as proxies for system-wide or nominal base line pressure, resulting in improperly configured systems that do not achieve preferred cross-flow rates for cleaning.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, are a method for cleaning a membrane filtration system comprising: providing a membrane filtration system comprising a base line supplying wash water to a membrane; maintaining a fluid pressure in the base line effective to cause the membrane to be cleaned by fluid cross-flow from the wash water.

In an embodiment, the cleaning comprises removing from a surface or pore of the membrane at least some solid particulate.

In a further embodiment, the membrane filtration system is configured in a cross-flow geometry.

In a further embodiment, the membrane filtration system is an ultrafiltration system or a microfiltration system.

In a further embodiment, the effective pressure in the base line is between 4 and 7 pounds per square inch.

In a further embodiment, the effective pressure in the base line is not less than 5 pounds per square inch.

In a further embodiment, the membrane filtration system is a reverse osmosis system or a nanofiltration system.

In a further embodiment, the effective pressure in the base line is between 100 and 400 pounds per square inch.

In a further embodiment, the membrane filtration system further comprises supplying to the base line permeate resulting from the cleaning of the membrane.

In a further embodiment, the maintaining step further comprises causing the membrane to be cleaned by the fluid cross-flow at least in part by supplying to base line the permeate.

In a further embodiment, the method further comprises: flushing at least some heavy solids from the membrane filtration system, the flushing step comprising supplying fresh water to the membrane filtration system and draining permeate and concentrate from the membrane filtration system; removing at least some solid particulates remaining in the membrane filtration system after the flushing step, the removing step comprising maintaining a fluid pressure in the base line effective to cause the membrane to be cleaned by fluid cross-flow across the membrane; after the removing step, draining soiled fluid from the membrane filtration system, the draining step comprising draining concentrate to waste; after the draining step, washing the membrane filtration system with clean wash solution, the washing step comprising recirculating the clean wash solution; and after the washing step, rinsing the membrane filtration system with clean wash water, the rinsing step comprising supplying fresh water to the membrane filtration system and draining permeate and concentrate to waste.

In a further embodiment, the method further comprises: in the flushing step, adding to the fresh water in the base line a cleaning solvent, the cleaning solvent cleaning the membrane.

In a further embodiment, the membrane filtration system comprises a dairy filtration system and the solid particulate includes proteins.

Also described herein, among other things, is a method for configuring a membrane filtration system comprising: providing a membrane filtration system comprising: a feed tank; a base line coupled to the feed tank through a feed pump configured to allow fluid flow from the feed tank into the base line; a chemical reservoir having therein a cleaning solvent, the chemical reservoir coupled to the base line through a chemical pump configured to allow the cleaning solvent to flow from the chemical reservoir to the base line; a membrane filtration unit comprising a plurality of vessels, the membrane filtration unit coupled to the base line through a recirculation pump configured to allow fluid flow from the base line to the membrane filtration units; a return line configured to allow permeate to flow from the membrane filtration unit to the feed tank; adding fresh water to the feed tank when the feed tank is substantially empty; when the feed tank is partially filled with fresh water, the feed pump pumping at least some of the fresh water in the partially filled feed tank into the base line, and the chemical pump pumping at least some of the cleaning solvent into the base line to mix with the fresh water; the recirculation pump pumping at least some of the fresh water-cleaning solvent mixture into the base line to the membrane filtration unit; cleaning the plurality of vessels with the cross-flow pressure of the fresh water-cleaning solvent mixture pumped into the membrane filtration units and producing permeate; directing the permeate to the feed tank through the return line.

In a further embodiment, the cleaning step comprises removing at least some solid particulate from a surface or pore of at least one vessel in the plurality of vessels.

In a further embodiment, the membrane filtration unit is an ultrafiltration unit or a microfiltration unit.

In a further embodiment, the method further comprises maintaining a fluid pressure effective to cause the plurality of vessels to be cleaned by fluid cross-flow.

In a further embodiment, the membrane filtration unit is a reverse osmosis unit or a nanofiltration unit.

In a further embodiment, the effective fluid pressure is between 100 and 400 pounds per square inch.

In a further embodiment, the membrane filtration system comprises a dairy filtration system and the solid particulates comprise proteins.

### BRIEF DESCRIPTION OF THE DRAWING

FIGS. 1A and 1B depict a schematic diagram of an exemplary embodiment of a membrane filtration system on which an exemplary embodiment of a method for cleaning a membrane separation system may be used.

FIG. 2A depicts a schematic diagram of an exemplary embodiment of a method for cleaning a membrane separation system.

FIG. 2B depicts an exemplary embodiment of a prior art method for cleaning a membrane separation system.

FIGS. 3A and 3B depict a schematic diagram of an exemplary embodiment of a membrane filtration system and method having a reclamation system on which an exemplary embodiment of a method for cleaning a membrane separation system may be used.

FIGS. 4A and 4B depict a schematic diagram of an alternative exemplary embodiment of a membrane filtration system and method in which permeate is returned to the feed tank.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Described herein, among other things, are methods for cleaning a membrane separation system wherein cross-flow of wash solution is used as the primary physical cleaning mechanism of a membrane, and the system is configured to maintain sufficient cross-flow by maintaining preferred pressure in supply lines supplying solution to the members. The described methods consume less water, use fewer chemicals, and reduce the operational downtime of the cleaning process compared with the prior art. The methods described herein differ from the prior art in several respects. These are further described below and include, but not limited to: inserting chemical cleaner into the initial fresh wash water at the outset, rather than pumping fresh was water alone in the system; eliminating an intermediate clean water rinse before the final flush of the system; taking pressure measurements at various points along the base line, rather than at the end alone; determining optimal chemical concentration by testing soil loading, rather than by simply adding chemical cleaner until the manufacturer-recommended level is achieved.

The method generally comprises flushing heavy solids from membranes, pre-wash recirculation, pre-wash draining to waste, wash recirculation, and rinsing. In an embodiment, the method also may comprise modifying a filtration system to include one or more additional components, including but not limited to return lines, pressure gauges, and pumps. Heavy solids vary from embodiment to embodiment depending upon the industry in which the filtration system is used. For example, in the dairy industry, heavy solids generally comprise solid particulates such as, without limitation, bacteria, fat, caseins, whey proteins, lactose, non-protein nitrogen, and salt.

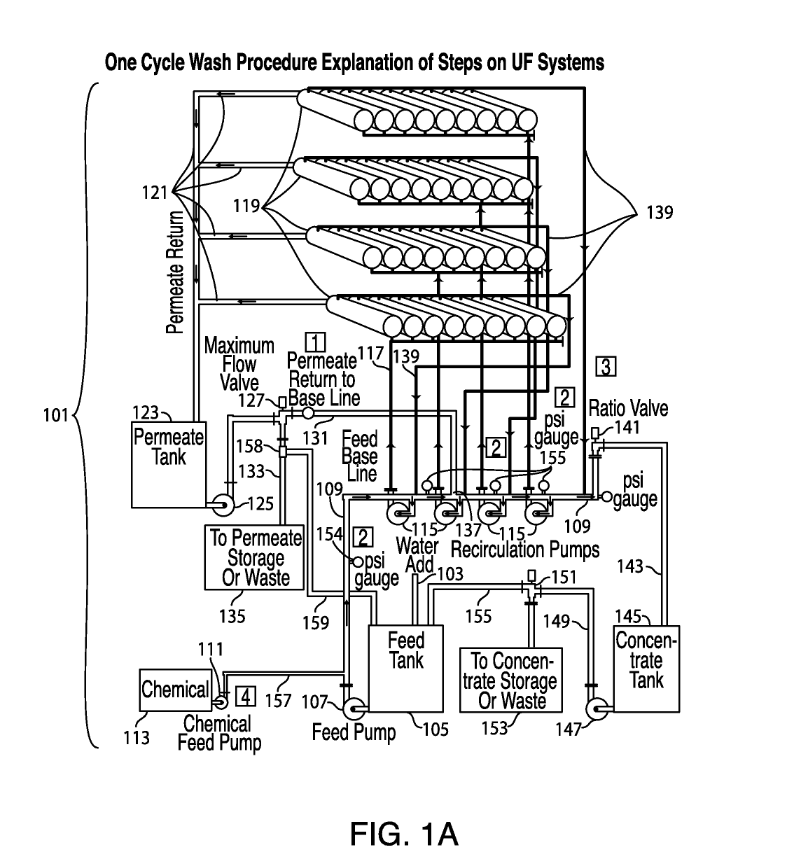

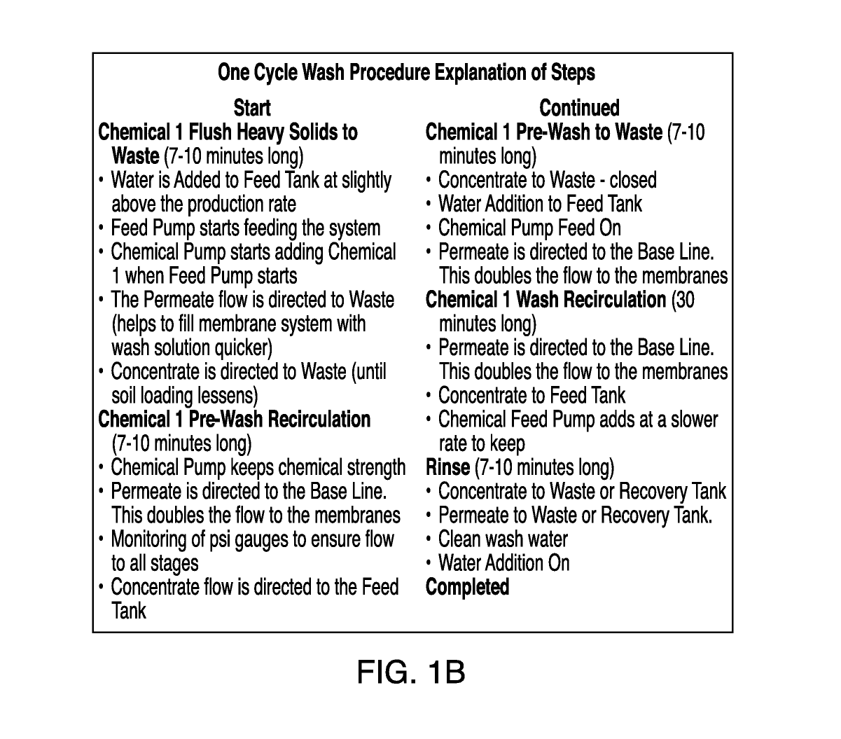

FIGS. 1A and 1B depict a membrane separation system using cross-flow geometry (101). In the depicted embodiment, fluid lines between components are depicted generally as unbroken pipes, but it will be understood by one of ordinary skill in the art that this is necessarily an abstraction of multiple components through which fluids may be routed. In an embodiment, such lines may comprise a plurality of pipes and/or other system components and/or valves. The depicted embodiment is intended to present an abstract of fluid flow in a system.

For sake of clarity, it is helpful to understand general fluid flow through an exemplary system. The system is generally described in the context of a wash cycle, but without respect to any particular cleaning method.

Feed is generally added to feed tank (105) via feed line (103). The “lines” and “returns” described herein will be understood by one of ordinary skill in the art as pipes or other conduits for moving fluid in the system. As described elsewhere herein, such lines and returns may comprise a single section of pipe may comprise a series of connected sections. “Feed” is generally a fluid and, more specifically, typically a liquid. For example, during normal production, feed may comprise milk in a dairy plant. However, during a wash cycle, feed typically comprises clean wash water.

Feed tank (105) retains the feed until feed pump (107) pumps feed from feed tank (105) to base line (109). Chemicals, such as cleaning solutions, are retained in chemical storage (113) and may be added to feed (e.g., water) in base line (109) through chemical line (157) by activating chemical feed pump (111). As feed passes through base line (109), feed encounters recirculating pump (115) or a series of recirculating pumps (115). Each of recirculating pumps (115) pump some portion of the feed from base line (109) into membrane feed line (117). Fluid in membrane feed line (117) enters filters (119) and is therein subjected to one or more membrane separation processes. As described elsewhere, the feed which penetrates the filters (e.g., is subject to the filtering, or separation, action of the membrane) is known as permeate. The feed which does not is known as retentate.

Permeate flows from filters (119) into permeate return lines (121), and permeate return lines (121) direct permeate into permeate tank (123). If permeate tank pump (125) is activated, permeate in permeate tank (123) is pumped to permeate return valve (127), which may direct permeate to feed return valve (158) or to permeate return line (131) to the base line (109). If permeate is directed to feed return valve (158), permeate may flow to waste line (133) and then to permeate waste/storage (135), or permeate may flow to permeate return line (159) to feed tank (105). Thus, when permeate return valve (127) is open, permeate is directed to permeate return line (131) to base line (109) and such permeate joins feed in base line (109). As described in more detail below, this improves pressure consistency in base line (109), which in turn provides sufficient cross-flow in vessels (119).

In an embodiment, permeate return line (131) to base line (109) connects to base line (109) at one or more locations. In a preferred embodiment, permeate return line (131) to base line (109) connects to base line (109) at a plurality of locations on base line (109). In a still further embodiment, one or more of such locations is between two recirculating pumps (115) in series.

Retentate (also sometimes referred to as concentrate) flows from filters (119) into retentate return lines (139), which lines (139) are connected to base line (109). Generally, retentate return line (139) from a given filter (119) connects to base line (109) at a location on base line (109) down-flow from the recirculation pump (115) which directs feed to the particular filter (119), and up-flow from the next recirculation pump (115) in series. If the particular filter (119) receives feed from the last recirculating pump (115) in series, retentate return line (139) generally connects to base line (109) at a location on base line (109) down-flow from that particular recirculating pump and up-flow from ratio valve (141). Ratio valve (141) may be closed, open, or partially open. For sake of clarity, fluid in the system down-flow of ratio valve (141), but not yet in the feed tank, is referred to herein as “concentrate” regardless of mixture content. When ratio valve (141) is open, concentrate (which may comprise a mixture of feed, retentate and/or permeate) flows to concentrate return line (143) which directs concentrate to concentrate tank (145). If concentrate pump (147) is activated, concentrate is pumped from concentrate tank (145) to concentrate waste valve (151). Concentrate waste valve (151) may direct concentrate to concentrate waste/storage (153) or to concentrate return line (155) to feed tank (105). Concentrate return line (155) to feed tank (105) in turn directs concentrate back to feed tank (105).

The method described herein generally comprises up to five phases, each of which in turn may comprise one or more method steps. The five phases are: flush heavy solids; chemical pre-wash recirculation; chemical pre-wash to waste; chemical wash recirculation; and rinse. Notably, unlike prior art systems, the method described herein does not require a fresh water rinse prior to the final rinse.

Generally, the first phase is flush heavy solids. During this phase, a mixture of cross-flow and trans-membrane pressure is used to dislodge heavy solids (sometimes called “cake” in the art) from membranes. Such dislodged solids are usually removed from the system by draining them to a waste storage or disposal system. FIGS. 1A and 1B depict an embodiment of a system which may be configured to use the cleaning method described herein. In the depicted embodiment, water is pumped into and recirculated through the system to dislodge heavy solids from fluid lines and membrane surfaces, and carry such heavy solids out of the system. The term heavy solids as used herein has the meaning known to one of ordinary skill in the art, and generally refers to solids accumulated on the membrane surface during production runs of the system. The composition of these solids will obviously depend on the type of membrane used.

In the depicted embodiment, a chemical, generally referred to herein as a “cleaning solution,” is pumped into the main feed line and circulated through the system to improve the efficiency of this process. This chemical may be any chemical solution, solute, or solvent known or in the future discovered or developed in the art which may be used for cleaning membrane separation systems, including but not limited to an alkaline, chlorine, or enzyme cleaning solution. In one exemplary embodiment, the cleaning solution comprises water mixed with a chemical. In an alternative embodiment, the “cleaning solution” is water and no additional chemical cleaning solution is pumped into the system.

It is generally desirable in the method to achieve a certain concentration of cleaning solution in the system. In an embodiment, the system is configured to supply chemical at a quantity and rate effective to achieve a concentration that is about equal to a preferred concentration. The preferred concentration will vary from embodiment to embodiment, and may vary by type of filtration system or membrane. Generally, the preferred concentration is the chemical manufacturer's recommended concentration, but may also be a concentration not greater than the maximum concentration recommended by the manufacturer of a particular membrane. In an alternative embodiment, the preferred chemical concentration may be determined through experimentation as described elsewhere herein.

It should be understood that chemical concentration may not be uniform throughout the system, and therefore, determining whether the concentration is about the preferred concentration may comprise measuring concentration at any point in the system or as a mean concentration across the system or a subsystem or plurality of subsystems. Concentration may be measured using any means now known or in the future developed in the art. In the depicted embodiment of FIGS. 1A and 1B, the chemical concentration is the concentration when the cleaning solution/feed mixture encounters the first membrane.

In the depicted embodiment of FIGS. 1A and 1B, permeate return valve (127) is closed in the flush heavy solids phase and permeate is not directed to permeate return (131) to base line (109). Permeate is instead directed to permeate to valve (158), which valve (158) directs permeate to waste (135). This configuration, among other things, facilitates the accumulation of cleaning solution in the system so that the concentration reaches a preferred concentration quickly.

Feed in the form of fresh water generally is added to feed tank (105) through feed line (103). The term “fresh water” as used herein generally means clean wash water from a clean water source, which may be a reclamation system. Fresh water is generally added to feed tank (105) at a flow rate higher than the production rate of the system. This is because, when cleaning, the preferred cross-flow rate in vessels (119) is generally higher than the production cross-flow rate, and achieving such preferred cross-flow rate requires more fluid in the system, particularly base line (109). Thus, feed pump (107) generally pumps water from feed tank (105) to base line (109) at a rate higher than the production pump rate. To maintain sufficient water supply in feed tank (105) for feed pump (107) to operate at this rate, the rate of water addition to feed tank (105) generally exceeds production rate.

After some amount of water accumulates in feed tank (105), feed pump (107) pumps water from feed tank (105) to base line (109). At about the same time that feed pump (107) activates, chemical pump (111) begins to pump cleaning solution from chemical storage (113) to chemical feed line (157). This causes chemicals to mix with water in base line (109) at an initial concentration. Chemical feed line (157) is connected to base line (109) at a location on base line (109) generally up-flow of a recirculating pump (115), which pump (115) may be the first recirculating pump (115) in a series of such pumps. The pump rate for chemical feed pump (111) is effective to cause the concentration to increase during the flush heavy solids phase until the concentration reaches a preferred concentration, or thereabout. The preferred concentration may vary from embodiment to embodiment, but will generally be near to, but lower than, the manufacturer-recommended maximum concentration for a particular chemical and/or membrane. The preferred concentration may be determined in an embodiment by experimentation. This approach begins the cleaning process at the outset of the cycle, whereas in prior art methods, chemical was added only after fresh water circulated through the system for some period of time.

Permeate return valve (127) in the depicted embodiment of FIGS. 1A and 1B is off, causing permeate to be directed to valve (158), which valve (158) is closed. Closed valve (158) directs permeate to waste line (133) and then to storage/waste (135). In this configuration, permeate does not flow through permeate return (131) to base line (109) and does not join the water/chemical mixture in base line (109). Rather, permeate flows to waste (135) for an amount of time. After such amount of time, valve (158) is opened to direct permeate to permeate return line (159) to feed tank (105). Thus, during the flush heavy solids phase, valve (158) initially directs permeate to storage (135), and then subsequently to feed tank (105).

The amount of time valve (158) directs permeate to waste (135) may vary from embodiment to embodiment, but is generally a sufficient amount of time for permeate to become generally free of visible heavy solids. This amount of time may be determined through experimentation. In the depicted embodiment of FIGS. 1A and 1B, the amount of time is about two minutes.

Ratio valve (141) is at least partially open during the flush heavy solids phase, allowing some flow of fluid to concentrate tank (145). By at least partially opening ratio valve (141), fluid pressure accumulates in the system, resulting in elevated trans-membrane pressure, or TMP, which encourages dislodging of heavy solids. However, high TMP inhibits high cross-flow rate. At the conclusion of the flush heavy solids phase, ratio valve (141) is opened further, reducing TMP and increasing cross-flow rate. Generally, ratio valve (141) is a stop valve down flow of vessels (119) which can be fully or partially opened, or fully or partially closed, and the extent to which ratio valve (141) is open or closed affects base line (109) fluid pressure and cross-flow rate in vessels (119).

In an embodiment, the extent to which ratio valve (141) is open or closed is effective to produce preferred cross-flow across membranes. In the depicted embodiment, when flush heavy solids phase concludes, the extent to which ratio valve (141) is open or closed is determined by the need to produce a fluid pressure in base line (109) effective to generate sufficient cross-flow across membranes such that cross-flow is the primary physical or mechanical interaction cleaning membranes. Such pressure level may vary from embodiment to embodiment, particularly by type of filtration system, and is described in more detail elsewhere herein.

During the flush heavy solids phase, concentrate valve (151) directs concentrate to concentrate storage/waste (153), preventing concentrate from entering concentrate return to feed (155). The primary sources directed to base line (109) in this phase are clean water from feed line (103) via feed tank (105), cleaning solution from chemical feed line (157), and retentate from retentate return lines (139). In an embodiment using reclamation, reclaimed permeate may indirectly enter base line (109) during this phase by being pumped from permeate tank (123) into feed tank (105) through an intermediate reclamation system.

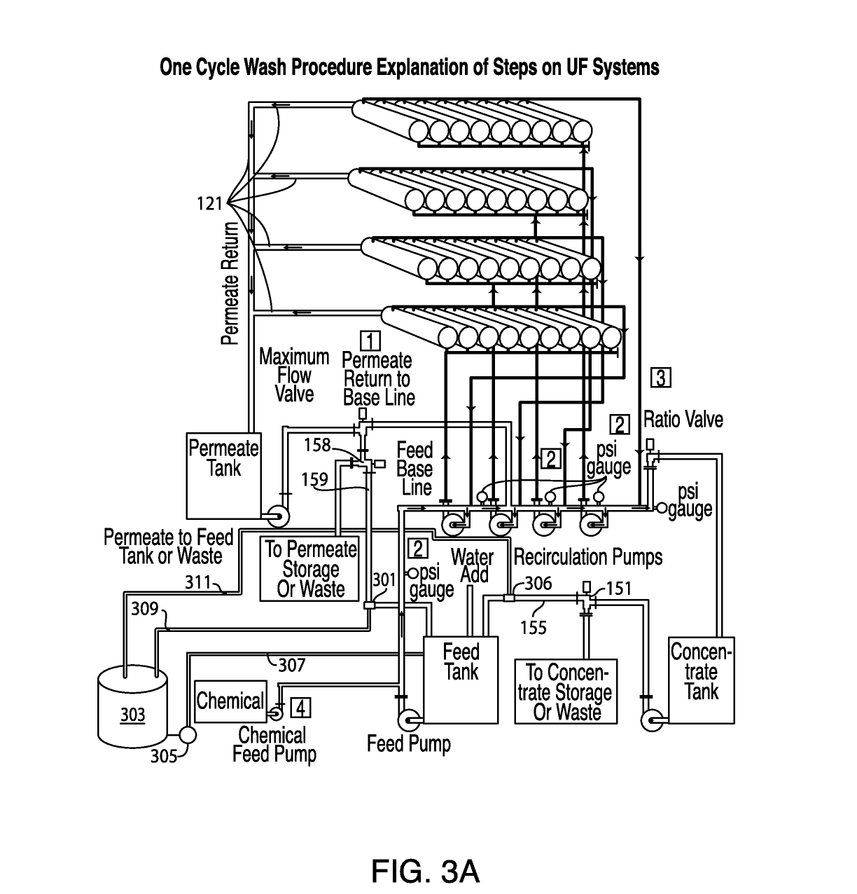

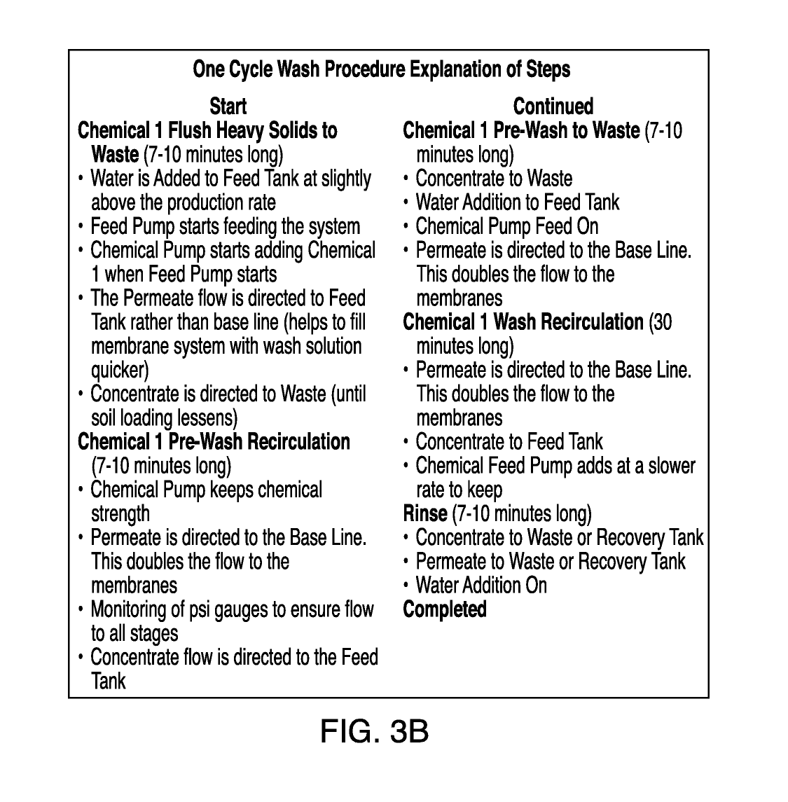

Because permeate is filtered (“clean”) material, permeate is generally directed to waste for only the first portion of the flush heavy solids phase, as described above, when permeate contains a large concentration of heavy solids. These solids are generally those particulates in the cake which would penetrate a clean membrane. By breaking up the cake, such solids penetrate the membrane and flow out of vessels (119) as permeate. As described above, permeate initially drains to waste until relatively clean of such heavy solids, and then is redirected to feed tank (105), either directly or indirectly through a reclamation system, such as the system depicted in FIGS. 3A and 3B and described in more detail elsewhere herein. In an embodiment, after permeate is directed to feed tank (105), more than half of the fluid pumped from feed tank (105) is comprised of permeate returned to feed tank (105) as opposed to fresh water during this phase. This approach reduces the volume of fresh water consumed by the method.

Other heavy solids which accumulated in the system during production, particularly foulants in vessels (119) on the membranes, are generally flushed from the system as retentate. In the depicted embodiment of FIGS. 1A and 1B, these materials are removed by closing concentrate return valve (151) to direct concentrate to waste (153), preventing foulants from reentering the system through feed tank (105). Because concentrate is comprised of a mixture of water and retentate during this phase, the concentrate generally will be a heavily soiled fluid mixture. By closing concentrate valve (151) and directing concentrate to waste (153), the system does not recirculate heavily soiled loads, which are likely to re-deposit on membranes as foulants.

When this phase begins, permeate will generally contain visible solids. The system operates in this configuration until such solids generally are no longer visible in permeate. Chemical verification may be used in an embodiment to determine whether soiling of permeate with heavy solids is sufficiently low to proceed to the next phase. At the conclusion of flush heavy solids phase, as described below in more detail, permeate is directed to base line (109) by opening permeate return valve (127).

The amount of time the system operates in this configuration may vary from embodiment to embodiment and may be determined experimentally for a given system. In the depicted embodiment of FIGS. 1A and 1B, an ultrafiltration system, the amount of time is seven to ten minutes. In another embodiment, this amount of time is not necessarily correlated with operational duration. In such an embodiment, the preferred amount of time may be used in the method after any production run regardless of duration.

After the flush heavy solids phase, chemical pre-wash recirculation begins. In this phase, remaining particulates are removed from membranes using primarily cross-flow physical interaction. For this interaction to effectively clean, cross-flow of solution must be at a preferred rate. In the depicted embodiment of FIGS. 1A and 1B, cross-flow is maintained at a preferred rate by sustaining a fluid pressure in base line (109) effective to produce the preferred cross-flow rate.

In the depicted embodiment of FIGS. 1A and 1B, chemical pump (111) continues to supply solution to maintain preferred concentration, but permeate return valve (127) is opened, causing permeate to flow to return line (131) and to base line (109) at one or more permeate return to base line connection points (137). Concentrate valve (151) is opened, causing concentrate to flow into concentrate return line (155) instead of concentrate waste/storage (153). Concentrate in concentrate return line (155) flows into feed tank (105), where it mixes with fresh water entering the system and is pumped by feed pump (107) back into base line (109).

When a sufficient fluid level is reached in feed tank (105), addition of fresh water from feed line (103) discontinues and the system begins to recirculate a volume of water mixture. This configuration accomplishes several things. In the prior art, ratio valve (141) is generally closed to produce increased system-wide pressure which in turn results in increased trans-membrane pressure, and lowering cross-flow rate, causing trans-membrane pressure to be the primary physical cleaning interaction between fluid and membrane. In the present systems and methods, ratio valve (141) is open during this phase, providing an additional evacuation route for fluid in base line (109). However, fluid evacuating base line (109) through ratio valve (141) could cause a loss in pressure in base line (109). By the configuration of the system as described herein, such loss is inhibited by supplying sufficient additional fluid to base line (109) to maintain preferred pressure. By recirculating fluid and maintaining preferred pressure in base line (109), the system achieves preferred cross-flow rate across membranes in vessels (119). The preferred cross-flow rate is a rate effective to clean membrane and/or remove cake and/or particulate. In an embodiment, the effective cross-flow rate is a rate effective to cause cross-flow to be the primary physical cleaning interaction between the fluid and membrane.

The preferred cross-flow rate will vary from embodiment to embodiment, and generally depends upon, among other things, the type of membrane or membranes in the system. The preferred cross-flow rate may be determined by, among other things, consulting a manufacturer's recommended rate for a given membrane, or through experimentation. In the depicted embodiment of FIGS. 1A and 1B, the preferred cross-flow rate is about 50 gallons per minute. The preferred cross-flow rate generally will not exceed a manufacturer's recommended maximum rate for a particulate membrane. In the depicted embodiment of FIGS. 1A and 1B, the recommended maximum cross-flow rate is about 80 gallons per minute. Although an exemplary preferred cross-flow rate is provided herein as a measure of gallons per minute, cross-flow rates may also be measured, approximated, or indicated through alternative means or proxy measures, including fluid pressure and pounds per square inch.

In the depicted embodiment of FIGS. 1A and 1B, preferred cross-flow rate is achieved by maintaining preferred fluid pressure in base line (109). In some embodiments, feed pump (107) may lack capacity to supply sufficient fluid to base line (109) to sustain preferred pressure. In such embodiments, pressure may be maintained in base line (109) at least in part by supplementing feed with permeate. In the depicted embodiment of FIGS. 1A and 1B, this is done by opening permeate return to feed valve (127) causing permeate to flow through return line (131) to base line (109). In another embodiment, opening concentrate valve (151) allows some amount of fluid otherwise exiting the system to be directed back into the system, reducing the amount of fresh water added to maintain preferred fluid pressure in the system. These configurations also reduce the amount of fresh water added to maintain preferred fluid pressure in base line (109).

This phase generally removes particulate remaining on or in the membranes after heavy solids have been generally removed, and drains remaining particulate from the system. Whereas prior art systems generally avoid recirculating prewash fluids to prevent re-deposition of removed particulate, this limitation in the prior art is a consequence of reliance on trans-membrane pressure for cleaning action. By contrast, the systems and methods described herein primarily use cross-flow rate for cleaning action, at a higher rate than in the prior art. Higher cross-flow rate inhibits re-deposition, allowing pre-wash recirculation with reduced fresh water consumption and reduced risk of particulate re-deposition, lowering overall operational cost while efficaciously cleaning the membranes.

The system described herein generally operates in this configuration until solids accumulate in the recirculated fluid. The amount of time the system operates in this configuration may vary from embodiment to embodiment, and particularly among types of separation/filtration systems, and may be experimentally determined for a given system. The amount of operational time for this phase may vary from embodiment to embodiment, particularly by type of filtration system, and may be experimentally determined for a given system. In the depicted ultrafiltration embodiment of FIGS. 1A and 1B, the system operates in this configuration for seven to ten minutes.

After the chemical pre-wash recirculation phase, the method enters the chemical pre-wash to waste phase. This phase generally removes from the system particulate accumulated in recirculated fluid during the prior phase. In an embodiment, this is done by draining soiled water from the system. In a further embodiment, soiled water is drained from the system in part by displacing it with fresh water added to the system. In a still further embodiment, the fresh water added to the system is supplemented by permeate to reduce overall water consumption.

In the depicted embodiment of FIGS. 1A and 1B, concentrate valve (151) is closed to inhibit concentrate from recirculating through the system and instead drained to waste (153). Permeate return valve (127) remains open to drain permeate flow to base line (109) rather than waste (135). Again, this helps maintain preferred fluid pressure in base line (109), producing preferred cross-flow across the membranes in filters (119) to inhibit re-deposition and effectuate cleaning action while consuming less fresh water added to the system. This is because the permeate is returned to the base line (109), as opposed to draining it to waste and pumping additional clean water into the system to maintain preferred cross-flow pressure. Because permeate is generally clean water, chemical consumption may also be reduced. Chemical pump (111) pumps solution at a rate effective to generally maintain a preferred concentration of cleaning solution in the system. Fresh water is added to tank (105) and pumped into base line (109) to displace soiled fluid, which drains to waste (145). Fresh water may be added through feed line (103), from a reclamation system, and may be supplemented by permeate. Permeate may be directed to base line (109) or to feed tank (105). Permeate may also supplement fresh water through a reclamation system.

In an embodiment, clean permeate is used to flush the system. In such an embodiment, the amount of fresh water added to flush the system is generally less than the known system capacity. In the depicted embodiment of FIGS. 1A and 1B, sufficient displacement of soiled fluid is achieved by flushing the system with a fluid mixture comprising 30-40% fresh water. In alternative embodiments, sufficient displacement of soiled fluid is achieved by flushing the system with a fluid mixture comprising: 0-5% fresh water; 5-10% fresh water; 10-20% fresh water; 20-30% fresh water; 30-40% fresh water; 40-50% fresh water; 50-60% fresh water; 60-70% fresh water; 70-80% fresh water; 80-90% fresh water; 90-100% fresh water.

The system operates in this configuration generally until the soiled fluid in the system has been generally displaced by a solution of fresh water and chemical, sometimes referred to as a clean wash solution. The amount of time required for this step can be calculated or approximated by dividing a known system fluid capacity by a feed rate, or may be determined experimentally. In the depicted embodiment of FIGS. 1A and 1B, the amount of time is seven to ten minutes.

After the chemical pre-wash to waste phase, the method enters the chemical wash recirculation phase. In this phase, clean wash solution is recirculated and effective cross-flow rate is maintained as discussed elsewhere herein to establish cross-flow as the primary mechanical interaction for cleaning, which rate also generally inhibits re-deposition. Heavy solids have been generally removed from the system by this phase and less soap is used to remove remaining particulates. Chemical concentration is gradually lowered to a preferred end of wash concentrate in preparation for final rinse.

The preferred end of wash concentration may vary from embodiment to embodiment. In an embodiment, the preferred end of wash concentration may be based on a solution manufacturer's recommendation, on other published recommendations, and/or may be determined through experimentation.

In the depicted embodiment of FIGS. 1A and 1B, permeate valve (127) and concentrate valve (151) are open, allowing permeate to supplement base line (109) and maintain preferred fluid pressure in base line (109) and corresponding preferred cross-flow rate. Concentrate flows to feed tank (105) rather than waste (153). Chemical pump (111) supply rate is reduced over time to lower concentration.

The amount of time for this phase may vary from embodiment to embodiment and in an embodiment may be determined experimentally. In the depicted embodiment of FIGS. 1A and 1B, the amount of time is about thirty minutes.

After the chemical wash recirculation phase, the method enters the rinse phase. In this phase, generally recirculation stops and the system is flushed and drained to prepare for production use. In one embodiment, this is done by recirculating clean wash water through the system to generally remove cleaning solution and rinse the system. This may include the addition of fresh water.

In the depicted embodiment of FIGS. 1A and 1B, permeate valve (127) is closed to drain permeate to permeate storage/waste (135) and concentrate valve (151) is closed to drain concentrate to concentrate storage/waste (153). Fresh water is added to feed tank (105) and pumped through the system by feed pump (107). Chemical pump (111) is inactive. The system is flushed and rinsed with clean wash water until cleaning solution concentration is below a preferred minimum. Generally, the preferred minimum is a concentration below which the system is deemed safe for operational use.

The duration of the rinse phase may vary from embodiment to embodiment and in an embodiment, may be experimentally determined. In the depicted embodiment of FIGS. 1A and 1B, the duration of the rinse cycle is about seven to ten minutes. In some alternative embodiments, there is no rinse cycle at all. This may be because no cleaning solution is used in such embodiment, or because ending concentration after wash recirculation is already below the preferred minimum for operational use.

A feature of the system is maintaining a preferred fluid pressure level in base line (109) effective to sustain a cross-flow rate effective to clean membranes in vessels (119). In certain embodiments, the system may include a plurality of pressure gauges (155) monitoring the fluid pressure at various points along feed line (109) to facilitate maintaining such effective pressure. It should be noted that this differs from prior art systems, which measure pressure only at or near the end of base line (109). Preferably, the system includes one pressure gauge (154) up flow of the first recirculating pump (115), and one pressure gauge (155) in base line (109) down flow from concentrate return line (139) for each recirculating pump but up flow from the next recirculating pump (115) in series. In an embodiment, one or more of such pressure gauges (155) are monitored and flow rates and line placement may be altered in an embodiment to achieve preferred fluid pressure.

In an embodiment of an ultrafiltration system, preferred fluid pressure is about 12-15 pounds per square inch in base line (109) up flow of first recirculating pump (115). In another exemplary embodiment of an ultrafiltration system, fluid pressure is about 4-7 pounds per square inch in base line (109) down flow of first recirculating pump (115). In the embodiment of an ultrafiltration system depicted in FIGS. 1A and 1B, preferred fluid pressure in base line (109) is at least 5 pounds per square inch down flow of first recirculating pump (115). Where a system does not include sufficient pressure gauges (154 and 155) properly placed to determine fluid pressure, the method may further comprise the step of modifying the system to include gauges (154 and 155).

In an exemplary embodiment, the method may further comprise the step of modifying the system to include permeate return to base line (131). In a further exemplary embodiment, the method may further comprise the step of modifying the system to include permeate return to feed valve (158) and permeate return to feed line (159). In a still further exemplary embodiment, the method may further comprise the step of modifying the system to include chemical pump (111) capable of supplying cleaning solution at a rate effective to achieve preferred concentrations.

In an exemplary embodiment, water is heated to improve cleaning. In a further embodiment, water is heated to between 100 and 122 degrees.

In a warm membrane system, there is risk that biofilm may develop during production. In such a system, variables, including but not necessarily limited to cross-flow rate, chemical concentration, operational time of a phase or portion thereof, fluid pressure, valve positioning, and other values may be determined in part based on the settings or values effective to remove and/or inhibit the development and/or growth of biofilm. By contrast, in one exemplary embodiment using a cold membrane system, no cleaning solution is used at all in the system and methods, and chemical pump (111) is inactive throughout all wash phases.

The cleaning method described herein may be applied to any industry using a membrane separation or filtration system, including but not limited to classic filtration, particle filtration, microfiltration (“MF”), ultrafiltration (“UF”), nanofiltration (“NF”), and reverse osmosis (“RO”) systems. The specific physical geometry of the system, such as location and placement of lines, valves, tanks, vessels, and other components, may vary from embodiment to embodiment, and particularly by type of separation/filtration system. Variables, including but not limited to pressures, concentrations, cross-flow rates, trans-membrane pressures, and cycle durations, may also vary from embodiment to embodiment, and particularly by type of separation/filtration system, in some cases substantially. By way of example and not limitation, whereas preferred base line (109) fluid pressure in the depicted embodiment of FIGS. 1A and 1B is about 5 PSI, preferred fluid pressure in an embodiment of a reverse osmosis system may be in excess of 1,000 PSI.

The method may be used in a system including a reclamation system. Such a system may, among other things, further reduce fresh water consumption. FIGS. 3A and 3B depict one exemplary embodiment of an ultrafiltration system having a reclamation system. The depicted system includes permeate reclamation valve (301) which may direct permeate from feed return line (159) to permeate reclamation line (309), which flows permeate to reclamation tank (303). In the depicted embodiment, the system further comprises concentrate reclamation valve (306) which may direct concentrate to concentrate reclamation line (311), which flows concentrate to reclamation tank (303). Reclamation tank (303) connects to reclamation pump (305), which, when activated, pumps reclaimed fluid to reclamation return line (307), which directs such fluid to feed tank (105).

To implement the method described herein in the depicted system, where concentrate valve (151) is open to return concentrate to feed tank (105), concentrate reclamation valve (306) may alternatively be configured to divert concentrate to reclamation tank (303), which in turn may pump (305) reclaimed fluid, which may comprise concentrate, to feed tank (105). Similarly, where valve (158) is open to return permeate to feed tank (105), permeate reclamation valve (301) may alternatively be configured to divert permeate to reclamation tank (303), which in turn may pump (305) reclaimed fluid, which may comprise permeate, to feed tank (105).

Other line geometries and configurations are possible and the systems and methods described herein are applicable to such geometries as well. FIGS. 3A and 3B present an exemplary embodiment of how the method described herein may be implemented in conjunction with a reclamation system, and should not be understood as limiting. Other geometries may include additional or different components not depicted which are or can be configured to facilitate fluid flow to a feed tank through a reclamation system.

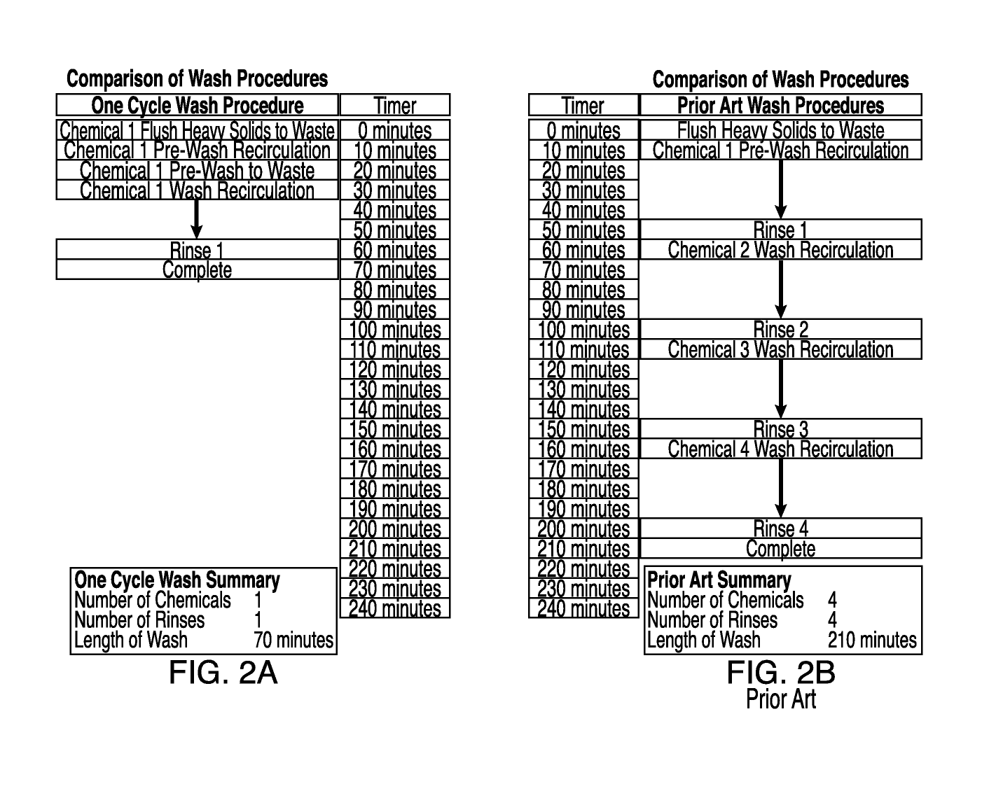

The method described achieves efficiencies over prior methods or systems, as shown in the side by side flow chart comparison of the one-cycle wash method described herein (FIG. 2A) with a prior art four-cycle wash system (FIG. 2B). The method reduces the number of chemicals used, reduces wear on membranes, reduces water consumption, and lowers operational downtime.

Certain system configurations are more effective for specific filtration systems. For example, the above-described systems are generally applicable to ultrafiltration and microfiltration systems. However, other types of filters, such as but not limited to reverse osmosis and nanofiltration systems, may use higher pressure at the vessel, which in turn uses higher pressure in the base line. For example, whereas the preferred or effective pressure for ultrafiltration or microfiltration systems may be in the single digits (e.g., subrange within the range of about 1-10 pounds per square inch), the pressure in the base line for RO/NF systems may exceed 100 pounds per square inch. Generally, for such systems the pressure is 100-400 pounds per square inch, achieving a vessel pressure level of 150-800 pounds per square inch.

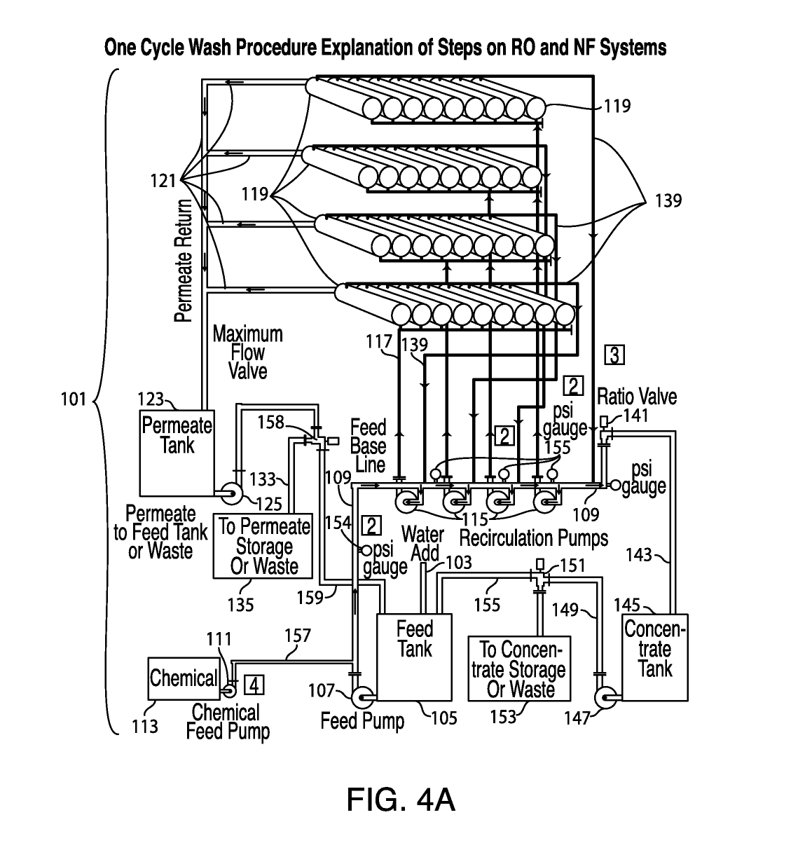

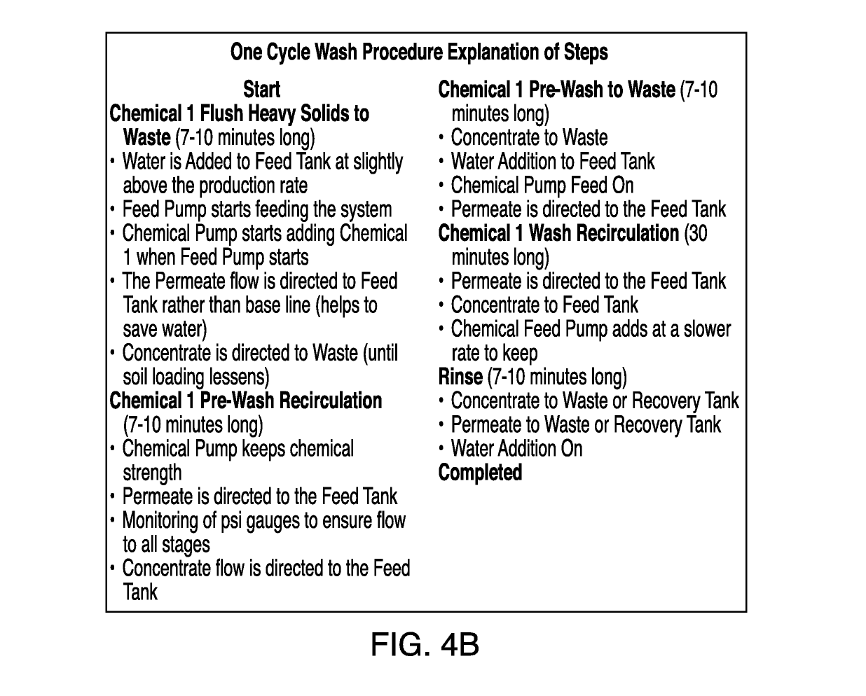

In RO/NF systems, directing permeate to base line (109) may complicate the system, such as by making pressure too difficult to maintain within the preferred operational range. In such systems, permeate may be directed instead to the feed tank. This has the added benefit of achieving still greater water efficiency. For example, in the embodiment depicted in FIGS. 4A and 4B, the system is configured slightly differently, which may achieve still greater water consumption efficiency. The embodiment of FIGS. 4A and 4B is substantially similar to the previously described embodiments with some variations as follows. In the depicted embodiment of FIGS. 4A and 4B, permeate in permeate tank (123) is pumped by pump (125) to feed return valve (158). During the flush heavy solids to waste phase, feed return valve (158) directs permeate to feed tank (105) via return line (159). This differs from other embodiments, in that other embodiments pump (125) permeate from permeate tank (123) to base line (109) via a permeate return to base line (131), which is not used in the depicted embodiment of FIGS. 4A and 4B.

In an embodiment, such as the embodiment depicted in FIGS. 4A and 4B, during the pre-wash recirculation phase, permeate is directed to feed tank (105) as described above, rather than to base line (109) as in other embodiments described herein. In an embodiment, such as the embodiment depicted in FIGS. 4A and 4B, during the pre-wash to waste phase, permeate is directed to feed tank (105) as described above, rather than to base line (109) as in other embodiments described herein. In an embodiment, such as the embodiment depicted in FIGS. 4A and 4B, during the wash recirculation phase, permeate is directed to feed tank (105) as described above, rather than to base line (109) as in other embodiments described herein. Such embodiments may achieve further decreased water consumption by supplementing feed tank (105) with permeate. This reduces the volume of fresh water (103) added to feed tank (105) to maintain desired system pressure and cross-flow pressure.

Another aspect of the systems and methods is that chemical consumption may be optimized through incremental testing. It should be noted that in the prior art, optimization of concentration is generally done through direct testing of samples for chemical concentration to determine whether the concentration is within a preferred range (such as, for example, a manufacturer's recommended range). However, this is not necessarily a good indicator of whether the concentration is optimized for a particular system and alternative proxies for optimal concentration may be used.

For example, generally there is a relationship, at least at the outset of a wash cycle, between the concentration of cleaning chemical in the wash water and the amount of solids in the retentate. More solids in the retentate suggest that more solids are removed from the filters by the mixture of wash water and cleaning chemical. As chemical concentration increases, cleaning action generally increases, and soil levels in the retentate likewise increase. However, there reaches a point of diminishing returns, where incremental additional chemical concentration does not achieve a corresponding increase in retentate solids. In the systems and methods described herein, chemical concentration may be optimized by taking samples of soil levels of retentate rather than direct measurement of concentration, and using the concentration approximately equal to the point at which marginal increases in soil levels are not commensurate with marginal increases in chemical concentration.

The specific concentration will necessarily vary from embodiment to embodiment, depending upon the industrial application of the filtration system. Additionally, the optimal chemical may also vary, as certain chemicals may achieve higher levels of cleaning (i.e., more solids in retentate) than other chemicals at the same concentration. Ordinary sampling and testing is used to identify optimal chemicals and concentrations. By way of example and not limitation, in a filtration system used in a dairy plant, heavy solids and solid particulates are generally proteins, and an enzyme-based cleaning solvent is generally an efficient cleaning solvent.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for cleaning a membrane filtration system comprising:
providing a membrane filtration system comprising a base line supplying wash water to a membrane;
maintaining a fluid pressure in said base line effective to cause said membrane to be cleaned by fluid cross-flow from said wash water.

2. The method as claimed in claim 1, wherein said cleaning comprises removing from a surface or pore of said membrane at least some solid particulate.

3. The method as claimed in claim 1, wherein said membrane filtration system is configured in a cross-flow geometry.

4. The method as claimed in claim 1, wherein said membrane filtration system is an ultrafiltration system or a microfiltration system.

5. The method as claimed in claim 4, wherein said effective pressure in said base line is between 4 and 7 pounds per square inch.

6. The method as claimed in claim 4, wherein said effective pressure in said base line is not less than 5 pounds per square inch.

7. The method as claimed in claim 1, wherein said membrane filtration system is a reverse osmosis system or a nanofiltration system.

8. The method as claimed in claim 7, wherein said effective pressure in said base line is between 100 and 400 pounds per square inch.

9. The method as claimed in claim 1, wherein said membrane filtration system further comprises supplying to said base line permeate resulting from said cleaning of said membrane.

10. The method as claimed in claim 9, wherein said maintaining step further comprises causing said membrane to be cleaned by said fluid cross-flow at least in part by supplying to base line said permeate.

11. The method as claimed in claim 1, wherein said method further comprises:
flushing at least some heavy solids from said membrane filtration system, said flushing step comprising supplying fresh water to said membrane filtration system and draining permeate and concentrate from said membrane filtration system;
removing at least some solid particulates remaining in said membrane filtration system after said flushing step, said removing step comprising maintaining a fluid pressure in said base line effective to cause said membrane to be cleaned by fluid cross-flow across said membrane;
after said removing step, draining soiled fluid from said membrane filtration system, said draining step comprising draining concentrate to waste;
after said draining step, washing said membrane filtration system with clean wash solution, said washing step comprising recirculating said clean wash solution; and
after said washing step, rinsing said membrane filtration system with clean wash water, said rinsing step comprising supplying fresh water to said membrane filtration system and draining permeate and concentrate to waste.

12. The method as claimed in claim 11, where said method further comprises:
in said flushing step, adding to said fresh water in said base line a cleaning solvent, said cleaning solvent cleaning said membrane.

13. The method as claimed in claim 12, wherein said membrane filtration system comprises a dairy filtration system and said solid particulate includes proteins.

14. A method for configuring a membrane filtration system comprising:
providing a membrane filtration system comprising:
a feed tank;
a base line coupled to said feed tank through a feed pump configured to allow fluid flow from said feed tank into said base line;
a chemical reservoir having therein a cleaning solvent, said chemical reservoir coupled to said base line through a chemical pump configured to allow said cleaning solvent to flow from said chemical reservoir to said base line;
a membrane filtration unit comprising a plurality of vessels, said membrane filtration unit coupled to said base line through a recirculation pump configured to allow fluid flow from said base line to said membrane filtration units;
a return line configured to allow permeate to flow from said membrane filtration unit to said feed tank;
adding fresh water to said feed tank when said feed tank is substantially empty;
when said feed tank is partially filled with fresh water, said feed pump pumping at least some of said fresh water in said partially filled feed tank into said base line, and said chemical pump pumping at least some of said cleaning solvent into said base line to mix with said fresh water;
said recirculation pump pumping at least some of said fresh water-cleaning solvent mixture into said base line to said membrane filtration unit;
cleaning said plurality of vessels with the cross-flow pressure of said fresh water-cleaning solvent mixture pumped into said membrane filtration units and producing permeate;
directing said permeate to said feed tank through said return line.

15. The method as claimed in claim 14, wherein said cleaning step comprises removing at least some solid particulate from a surface or pore of at least one vessel in said plurality of vessels.

16. The method as claimed in claim 14, wherein said membrane filtration unit is an ultrafiltration unit or a microfiltration unit.

17. The method as claimed in claim 14 further comprising maintaining a fluid pressure effective to cause said plurality of vessels to be cleaned by fluid cross-flow.

18. The method as claimed in claim 17, wherein said membrane filtration unit is a reverse osmosis unit or a nanofiltration unit.

19. The method as claimed in claim 18, wherein said effective fluid pressure is between 100 and 400 pounds per square inch.

20. The method as claimed in claim 14, wherein said membrane filtration system comprises a dairy filtration system and said solid particulates comprise proteins.
